(19) United States
(12) Patent Application Publication
(10) Pub. No.: US 2022/0356284 A1
(43) Pub. Date: Nov. 10, 2022

(54) HEAT-STABILIZED AQUEOUS COMPOSITION

(71) Applicant: COATEX, Genay (FR)

(72) Inventors: Lori HOWELL, Newberry, SC (US); Haksu LEE, Waxhaw, NC (US); Benoit MAGNY, Fontaines Saint Martin (FR); Yves MATTER, Reyrieux (FR); Denis RUHLMANN, Genay (FR); Jean Marc SUAU, Lucenay (FR)

(73) Assignee: COATEX, Genay (FR)

(21) Appl. No.: 17/785,547

(22) PCT Filed: Dec. 14, 2020
(86) PCT No.: PCT/FR2020/000272

§ 371 Date: Jun. 15, 2022

(30) Foreign Application Priority Data
Dec. 16, 2019 (FR) 19 14493

(51) Int. Cl. C08F 220/18; C09D 7/65; C09D 7/48

(52) U.S. Cl. CPC C08F 220/1802; C09D 7/65; C09D 7/48

(57) ABSTRACT

A preparation of an aqueous composition that is resistant to temperature variations may include the use of at least one specific heat-stabilizing agent. The heat stabilization of the viscosity of the aqueous composition within a wide temperature range. Such heat-stabilizing agents may include, in polymerized form: (a1) an anionic monomer comprising a polymerizable olefinic unsaturation and a carboxylic acid group, optionally in salt form; (a2) a C1-C7 ester of acrylic acid, methacrylic acid, maleic acid, and/or itaconic acid; (a3) an associative monomer of a formula, R¹-(EO)ₘ-(PO)ₙ-R², wherein m and n are independently 0 or an integer or decimal less than 150, m or n being different from 0, EO is independently a CH₂CH₂O group, PO is independently a combination of (i) CH₂CH₂O and (ii) CH(CH₃)CH₂O and/or CH₂CH(CH₃)O, R¹ is independently a group comprising a polymerizable olefinic unsaturation, and R² is independently a straight C₂₈-C₄₀-alkyl group or a C₂₈-C₄₀-alkyl group.

The invention relates to the preparation of an aqueous composition that is resistant to temperature variations due to the use of at least one specific heat-stabilising agent (P). It also relates to the heat stabilisation of the viscosity of the aqueous composition within a wide temperature range.

Many technical areas require the use of aqueous compositions. These include, in particular, aqueous hydraulic binder compositions, aqueous adhesive compositions, aqueous detergent compositions, aqueous cosmetic compositions, aqueous ink compositions, aqueous paper coating compositions, aqueous coating compositions, in particular aqueous varnish compositions or aqueous paint compositions, particularly aqueous decorative paint compositions or aqueous industrial paint compositions.

In addition to their functional properties, these aqueous compositions must have a texture adapted to their use or to their storage. In particular, they must have a viscosity adapted to their use or to their storage.

Moreover, it must be possible to use these aqueous compositions in conditions that can vary greatly. In particular, these aqueous compositions must be used under variable temperature conditions. Indeed, the properties of these aqueous compositions may change or degrade when the temperature changes, both for temperature increases and temperature decreases.

In particular, the viscosity of these aqueous compositions may change or degrade when the temperature changes. The functional properties of these aqueous compositions may therefore be altered if their viscosity changes or degrades when the temperature changes. Such changes or degradations are particularly detrimental or damaging to aqueous hydraulic binder compositions, to aqueous adhesive compositions, to aqueous detergent compositions, to aqueous cosmetic compositions, to aqueous ink compositions, to aqueous paper coating compositions, to aqueous coating compositions, in particular to aqueous varnish compositions or to aqueous paint compositions.

There is therefore a need to be able to have aqueous compositions that do not have such disadvantages or aqueous compositions that do not lead to such problems.

In particular, it is particularly useful to be able to have aqueous coating compositions, in particular aqueous varnish compositions or aqueous paint compositions, with thermally stable viscosity. Such aqueous compositions, having little or no change in viscosity when the temperature at the time of their use is above 5° C. or when this temperature is below 50° C., are particularly desirable. These properties are also sought for intermediate temperature ranges that correspond to frequently-encountered conditions of use, for example from 5 to 15° C., from 15 to 35° C., or from 30 to 50° C.

Moreover, maintaining the viscosity and limiting the loss of viscosity of these aqueous compositions should be possible for wide ranges of shear gradients, for example from 0.1 to 1,000 s⁻¹, from 0.1 to 100 s⁻¹, from 1 to 100 s⁻¹ or from 0.1 to 1 s⁻¹.

Document EP 979833 describes thickening compounds for aqueous compositions to maintain or increase the viscosity of these compositions. These thickening compounds can be prepared from straight C₁₇-alkyl itaconates or from straight C₂₂-alkyl or di-nonylphenol itaconates. Document WO 2011161508 describes (H)ASE polymers prepared using 2-acrylamido-2-methylpropane sulphonic acid and a monomer comprising a straight C₂₂-alkyl group. The article by Tam et al. entitled “Rheological properties of hydrophobically modified alkali-swellable polymers—effects of ethylene-oxide chain length”, published in 1998, relates to a study of various effects of ethoxylated chain lengths in HASE polymers. It describes in particular the level of activation energy that results from the dissociation of the hydrophobic end group for these polymers.

There is thus a need to have improved aqueous compositions.

The method according to the invention makes it possible to prepare an aqueous composition that provides a solution to all or part of the problems of the aqueous compositions in the prior art.

The invention thus provides a method for preparing an aqueous composition that is heat-resistant to temperature variations, comprising the addition of at least one heat-stabilising agent (P) prepared by at least one polymerisation reaction:
(a1) of at least one anionic monomer comprising at least one polymerisable olefinic unsaturation and at least one carboxylic acid group or of one of its salts;
(a2) of at least one C₁-C₇ ester of a compound derived from an acid chosen among acrylic acid, methacrylic acid, maleic acid and itaconic acid;
(a3) of at least one associative monomer of formula (I):

R¹-(EO)ₘ-(PO)ₙ-R² (I)

wherein:
m and n, identical or different, independently represent 0 or an integer or decimal less than 150, m or n being different from 0,
EO independently represents a CH₂CH₂O group,
PO independently represents a combination of CH₂CH₂O groups and of groups chosen among CH(CH₃)CH₂O and CH₂CH(CH₃)O,
R¹ independently represents a group comprising at least one polymerisable olefinic unsaturation and
R² independently represents a straight C₂₈-C₄₀-alkyl group or a branched C₂₈-C₄₀-alkyl group.

Preferably according to the invention, the aqueous composition is a composition chosen among a hydraulic binder composition, an adhesive composition, a detergent composition, a cosmetic composition, an ink composition, an aqueous paper coating composition, a coating composition. Preferably according to the invention, the aqueous composition is a varnish composition or a paint composition or a decorative paint composition or an industrial paint composition.

The aqueous composition according to the invention comprises at least one heat-stabilising agent (P).

Preferably according to the invention, the agent (P) is an associative compound. An associative compound makes it possible to produce associative bonds when using the composition according to the invention. These associative bonds generally develop between chemical groups of the same nature, particularly between hydrophobic groups. Preferably according to the invention, the monomer (a1) is chosen among acrylic acid, methacrylic acid, an acrylic acid salt, a methacrylic acid salt and combinations thereof.

Also preferably according to the invention, the monomer (a2) is a C₁-C₆ ester or a C₁-C₄ ester or is a C₁-C₇ acrylic acid ester or a C₁-C₇ methacrylic acid ester, preferably chosen among methyl acrylate, ethyl acrylate, propyl acrylate, butyl acrylate, ethyl hexyl acrylate, methyl methacrylate, ethyl methacrylate, propyl methacrylate, butyl methacrylate, ethyl hexyl methacrylate and combinations thereof, more preferentially ethyl acrylate, butyl acrylate, methyl methacrylate and combinations thereof.

Also preferably according to the invention, the monomer (a3) is a compound of formula (I) wherein:
m and n, identical or different, independently represent 0 or an integer or decimal less than 150, m or n being different from 0,
EO independently represents a CH₂CH₂O group,
PO independently represents a combination of CH₂CH₂O groups and of groups chosen among CH(CH₃)CH₂O and CH₂CH(CH₃)O,
R¹ independently represents a group comprising at least one polymerisable olefinic unsaturation and
R² independently represents a straight C₃₂-C₄₀-alkyl group or a branched C₃₂-C₄₀-alkyl group or a straight C₃₀-C₃₆-alkyl group or a branched C₃₀-C₃₆-alkyl group; preferably a straight C₃₂-C₃₆-alkyl group or a branched C₃₂-C₃₆-alkyl group; more preferentially a branched C₃₂-alkyl group.

More preferably according to the invention, the monomer (a3) is a compound of formula (I) wherein:
m and n, identical or different, independently represent 0 or an integer or decimal less than 150, m or n being different from 0,
EO independently represents a CH₂CH₂O group,
PO independently represents a combination of CH₂CH₂O groups and of groups chosen among CH(CH₃)CH₂O and CH₂CH(CH₃)O,
R¹ independently represents an acrylate group or a methacrylate group and
R² independently represents a straight C₃₂-C₄₀-alkyl group or a branched C₃₂-C₄₀-alkyl group or a straight C₃₀-C₃₆-alkyl group or a branched C₃₀-C₃₆-alkyl group; preferably a straight C₃₂-C₃₆-alkyl group or a branched C₃₂-C₃₆-alkyl group; more preferentially a branched C₃₂-alkyl group.

Preferably according to the invention, the agent (P) is prepared by at least one polymerisation reaction:
of from 20 to 55% by weight of monomer (a1),
of from 20 to 79.5% by weight of monomer (a2),
of from 0.5 to 25% by weight of monomer (a3),

relative to the total amount by weight of monomers.

Also preferably according to the invention, the agent (P) is prepared by at least one polymerisation reaction:
of from 25 to 45% by weight of monomer (a1),
of from 35 to 74% by weight of monomer (a2),
of from 1 to 20% by weight of monomer (a3),

relative to the total amount by weight of monomers.

Also more preferably according to the invention, the agent (P) is prepared by at least one polymerisation reaction:
of from 30 to 40% by weight of monomer (a1),
of from 45 to 67% by weight of monomer (a2),
of from 3 to 15% by weight of monomer (a3),

relative to the total amount by weight of monomers.

Also more preferably according to the invention, the agent (P) is prepared by at least one polymerisation reaction:
of from 30 to 45% by weight of monomer (a1),
of from 43 to 65% by weight of monomer (a2),
of from 5 to 12% by weight of monomer (a3),

relative to the total amount by weight of monomers.

The agent (P) is generally known as such. It can be prepared with the preparation methods of the prior art. When preparing the agent (P) according to the invention, the amounts of reagents used may vary.

According to the invention, the heat-stabilising agent (P) can be prepared by polymerisation reaction of at least one compound (a1), of at least one compound (a2) and of at least one compound (a3). The heat-stabilising agent (P) can be prepared by polymerisation reaction of the compounds (a1), (a2) and (a3) alone.

In addition to compounds (a1), (a2) and (a3), the agent (P) can be prepared by a polymerisation reaction that also uses:
(a4) at least one compound chosen among 2-acrylamido-2-methylpropane sulphonic acid, ethoxymethacrylate sulphonic acid, sodium methallyl sulphonate, styrene sulphonate, hydroxyethyl acrylate phosphate, hydroxypropyl acrylate phosphate, hydroxyethylhexyl acrylate phosphate, hydroxyethyl methacrylate phosphate, hydroxypropyl methacrylate phosphate, hydroxyethylhexyl methacrylate phosphate, their salts and combinations thereof, preferably less than 20% by weight or from 0.2 to 20% by weight, in particular from 0.5 to 10% by weight, of monomer (a4) relative to the total amount by weight of monomers or
(a5) at least one compound chosen among hydroxyethyl acrylate, hydroxypropyl acrylate, hydroxyethylhexyl acrylate, hydroxyethyl methacrylate, hydroxypropyl methacrylate, hydroxyethylhexyl methacrylate, preferably less than 20% by weight or from 0.2 to 20% by weight, in particular from 0.5 to 10% by weight, of monomer (a5) relative to the total amount by weight of monomers or
(a6) at least one cross-linking monomer or at least one monomer comprising at least two olefinic unsaturations, preferably less than 5% by weight or from 0.01 to 4% by weight, in particular from 0.02 to 4% by weight or from 0.02 to 2% by weight or from 0.02 to 0.5% by weight, of monomer (a6) relative to the total amount by weight of monomers or
(a7) at least one chain transfer agent, preferably at least one mercaptan compound, more preferentially a mercaptan compound comprising at least four carbon atoms, much more preferentially a mercaptan compound chosen among butyl mercaptan, n-octyl mercaptan, n-dodecyl mercaptan, tert-dodecyl mercaptan and combinations thereof, preferably less than 5% by weight or from 0.01 to 4% by weight, in particular from 0.02 to 4% by weight or from 0.02 to 2% by weight or from 0.02 to 0.5% by weight, of monomer (a7) relative to the total amount by weight of monomers.

The agent (P) can be used directly or in a fully or partially neutralised form or in a coacervated form.

Preferably according to the invention, the agent (P) can be fully or partially neutralised, preferably by means of at least one compound chosen among NaOH, KOH, ammonium derivatives, ammonia, amine bases, for example triethanolamine, aminomethyl propanol or 2-amino-2-methyl-propanol (AMP) and combinations thereof.

Also preferably according to the invention, the agent (P) can be partially coacervated. Preferably, it can be coacervated:
by reducing the pH, for example by reducing the pH to a value of less than 6.5, in particular by means of an acid compound, in particular by means of least one organic or inorganic acid compound, in particular an acid compound chosen among phosphoric acid, citric acid, glucono-lactone, lactic acid, salicylic acid, glycolic acid, ascorbic acid, glutamic acid, hydrochloric acid, acetic acid, D-gluconic acid, sulphonic acid, methanesulphonic acid, benzimidazole sulphonic acid, tartaric acid, 4-aminobenzoic acid, benzoic acid, sorbic acid, phenylbenzimidazole sulphonic acid, benzylidene camphor sulphonic acid, terephthalylidene dicamphor sulphonic acid, kojic acid, hyaluronic acid or
by increasing the ionic strength, for example by adding at least one ionised compound or at least one salt, in particular NaCl, KCl, MgCl₂, CaCl₂, MgSO₄, CaSO₄ or by adding phenylbenzimidazole sulphonic acid (PBSA) or pyroglutamic acid sodium salt (NaPCA).

According to the invention, the amounts of agent (P) used may vary. Preferably, the aqueous composition according to the invention comprises from 0.05 to 5% by weight, preferably from 0.1 to 2% by weight, of agent (P) relative to the total weight of the composition. According to the invention, the amounts of agent (P) used are thus expressed as dry amounts of agent (P).

The use of the heat-stabilising agent (P) according to the invention provides the aqueous composition with a heat-resistant function or a resistant function with regard to temperature changes. These functions can be advantageously used when the aqueous composition is subjected to an increase in temperature or when the aqueous composition is subjected to a decrease in temperature.

In addition to being heat-resistant or resisting temperature changes in the aqueous composition according to the invention, the use of the agent (P) according to the invention makes it possible to influence the viscosity of the composition according to the invention. In particular, the agent (P) makes it possible to obtain an aqueous composition with a viscosity that is thermally stable at low shear gradient or at medium shear gradient, potentially at high shear gradient.

According to the invention, the efficacy of the heat-stabilising agent (P) is assessed by measuring the viscosity and the change in this viscosity. Thus, the agent (P) is used in an aqueous formulation for which the viscosity is assessed after 24 hours by measuring flow curves for various shear gradients (Thermo Scientific Mars III rheometer using a cone-planar geometry of 60 mm in diameter with a 1° angle) and at different temperatures. According to the invention, the initial viscosity is the viscosity measured at a particular shear gradient before changing the temperature within a set temperature range. The change in viscosity can then be assessed by comparing a particular viscosity value with the initial viscosity.

Preferably, the change in viscosity is assessed for temperature changes ranging from 5 to 50° C. or ranging from 30 to 50° C. or ranging from 15 to 35° C. or ranging from 5 to 15° C. For these temperature ranges, the initial viscosity is the viscosity measured at 5° C., at 30° C., at 15° C. and at 5° C., respectively.

The efficacy of the heat-stabilising agent (P) according to the invention can be assessed by comparing it with similar formulations that do not comprise a heat-stabilising agent (P) but that do have a comparative polymer.

Essentially according to the invention, the heat-stabilising agent (P) makes it possible to keep the viscosity of the aqueous composition high for wide temperature ranges. The heat-stabilising agent (P) also makes it possible to keep the viscosity of the aqueous composition high for numerous shear gradients, preferably for wide temperature ranges.

Thus, preferably according to the invention, the aqueous composition has a viscosity measured for a shear gradient ranging from 0.1 to 1,000 s⁻¹ and for a temperature change ranging from 5 to 50° C., comprised between 50% and 98%, preferably between 61% and 98%, of the initial viscosity value of the aqueous composition.

Also according to the invention, the aqueous composition has a viscosity measured for a shear gradient ranging from 0.1 to 1,000 s⁻¹ and for a temperature change ranging from 30 to 50° C., comprised between 70% and 98%, preferably between 79% and 98%, of the initial viscosity value of the aqueous composition.

Also according to the invention, the aqueous composition has a viscosity measured for a shear gradient ranging from 0.1 to 1,000 s⁻¹ and for a temperature change ranging from 15 to 35° C., comprised between 70% and 98%, preferably between 79% and 98%, of the initial viscosity value of the aqueous composition.

Also according to the invention, the aqueous composition has a viscosity measured for a shear gradient ranging from 0.1 to 1,000 s⁻¹ and for a temperature change ranging from 5 to 15° C., comprised between 80% and 98%, preferably between 86% and 98%, of the initial viscosity value of the aqueous composition.

Also preferably according to the invention, the aqueous composition has a viscosity measured for a shear gradient ranging from 0.1 to 100 s⁻¹ and for a temperature change ranging from 5 to 50° C., comprised between 50% and 98%, preferably between 58% and 98%, of the initial viscosity value of the aqueous composition.

Also according to the invention, the aqueous composition has a viscosity measured for a shear gradient ranging from 0.1 to 100 s⁻¹ and for a temperature change ranging from 30 to 50° C., comprised between 70% and 98%, preferably between 78% and 98%, of the initial viscosity value of the aqueous composition.

Also according to the invention, the aqueous composition has a viscosity measured for a shear gradient ranging from 0.1 to 100 s⁻¹ and for a temperature change ranging from 15 to 35° C., comprised between 70% and 98%, preferably between 77% and 98%, of the initial viscosity value of the aqueous composition.

Also according to the invention, the aqueous composition has a viscosity measured for a shear gradient ranging from 0.1 to 100 s⁻¹ and for a temperature change ranging from 5 to 15° C., comprised between 80% and 98%, preferably between 88% and 98%, of the initial viscosity value of the aqueous composition.

Also preferably according to the invention, the aqueous composition has a viscosity measured for a shear gradient ranging from 1 to 100 s⁻¹ and for a temperature change ranging from 5 to 50° C., comprised between 50% and 98%, preferably between 58% and 98%, of the initial viscosity value of the aqueous composition.

Also according to the invention, the aqueous composition has a viscosity measured for a shear gradient ranging from 1 to 100 s⁻¹ and for a temperature change ranging from 30 to 50° C., comprised between 70% and 98%, preferably between 78% and 98%, of the initial viscosity value of the aqueous composition.

Also according to the invention, the aqueous composition has a viscosity measured for a shear gradient ranging from 1 to 100 s⁻¹ and for a temperature change ranging from 15 to 35° C., comprised between 70% and 98%, preferably between 78% and 98%, of the initial viscosity value of the aqueous composition.

Also according to the invention, the aqueous composition has a viscosity measured for a shear gradient ranging from 1 to 100 s⁻¹ and for a temperature variation ranging from 5 to 15° C., comprised between 80% and 98%, preferably between 88% and 98%, of the initial viscosity value of the aqueous composition.

Also preferably according to the invention, the aqueous composition has a viscosity measured for a shear gradient ranging from 0.1 to 1 s⁻¹ and for a temperature change ranging from 5 to 50° C., comprised between 55% and 98%, preferably between 62% and 98%, of the initial viscosity value of the aqueous composition.

Also according to the invention, the aqueous composition has a viscosity measured for a shear gradient ranging from 0.1 to 1 s⁻¹ and for a temperature change ranging from 30 to 50° C., comprised between 70% and 98%, preferably between 78% and 98%, of the initial viscosity value of the aqueous composition.

Also according to the invention, the aqueous composition has a viscosity measured for a shear gradient ranging from 0.1 to 1 s⁻¹ and for a temperature change ranging from 15 to 35° C., comprised between 70% and 98%, preferably between 78% and 98%, of the initial viscosity value of the aqueous composition.

Also according to the invention, the aqueous composition has a viscosity measured for a shear gradient ranging from 0.1 to 1 s⁻¹ and for a temperature change ranging from 5 to 15° C., comprised between 80% and 98%, preferably between 88% and 98%, of the initial viscosity value of the aqueous composition.

In addition to maintaining viscosity, the heat-stabilising agent (P) also advantageously enables the viscosity of the aqueous composition to be thermally stabilized for many shear gradient values and for wide temperature ranges relative to the initial viscosity of the aqueous composition. Thus, the agent (P) makes it possible to limit the loss of viscosity of the aqueous composition subject to a temperature change. The agent (P) used according to the invention makes it possible to limit the viscosity loss for various shear gradients applied to the aqueous composition, and therefore for different conditions in which this composition is used.

The heat stabilisation method according to the invention is particularly advantageous when there are temperature changes during preparation or during transport or during storage, and even more so during the application or use of the aqueous composition according to the invention. Preferably, the heat stabilisation method according to the invention makes it possible to limit or avoid the reduction in the viscosity of the aqueous composition according to the invention when there are temperature changes during the application or use of the aqueous composition according to the invention. Preferably, the heat stabilisation method according to the invention makes it possible to limit or avoid the reduction in the viscosity of the aqueous composition according to the invention for temperature changes ranging from 5 to 50° C. or ranging from 30 to 50° C. or ranging from 15 to 35° C. or ranging from 5 to 15° C.

Thus, the invention provides a method of heat stabilisation of the viscosity of an aqueous composition comprising the addition of at least one agent (P) according to the invention to the aqueous composition.

Particularly advantageously, the heat stabilisation method according to the invention makes it possible to limit or avoid the reduction of the viscosity of the aqueous composition according to the invention during temperature changes.

Preferably, the method of heat stabilisation of the viscosity of an aqueous composition comprises the addition of at least one heat-stabilising agent (P) to the aqueous composition for which the decrease in viscosity measured for a shear gradient ranging from 0.1 to 1,000 s⁻¹ is less than 45%, preferably less than 39%, for a temperature range of from 5 to 50° C., relative to the initial viscosity of the aqueous composition.

Also according to the invention, the method of heat stabilisation of the viscosity of an aqueous composition comprises the addition of at least one heat-stabilising agent (P) to the aqueous composition for which the decrease in viscosity measured for a shear gradient ranging from 0.1 to 1,000 s⁻¹ is less than 30%, preferably less than 21%, for a temperature range of from 30 to 50° C., relative to the initial viscosity of the aqueous composition.

Also according to the invention, the method of heat stabilisation of the viscosity of an aqueous composition comprises the addition of at least one heat-stabilising agent (P) to the aqueous composition for which the decrease in viscosity measured for a shear gradient ranging from 0.1 to 1,000 s⁻¹ is less than 30%, preferably less than 25%, for a temperature range of from 15 to 35° C., relative to the initial viscosity of the aqueous composition.

Also according to the invention, the method of heat stabilisation of the viscosity of an aqueous composition comprises the addition of at least one heat-stabilising agent (P) to the aqueous composition for which the decrease in viscosity measured for a shear gradient ranging from 0.1 to 1,000 s⁻¹ is less than 20%, preferably less than 14%, for a temperature range of from 5 to 15° C., relative to the initial viscosity of the aqueous composition.

Also preferably, the method of heat stabilisation of the viscosity of an aqueous composition comprises the addition of at least one heat-stabilising agent (P) to the aqueous composition for which the decrease in viscosity measured for a shear gradient of from 0.1 to 100 s⁻¹ is less than 50%, preferably less than 42%, for a temperature range of from 5 to 50° C., relative to the initial viscosity of the aqueous composition.

Also according to the invention, the method of heat stabilisation of the viscosity of an aqueous composition comprises the addition of at least one heat-stabilising agent (P) to the aqueous composition for which the decrease in viscosity measured for a shear gradient ranging from 0.1 to 100 s⁻¹ is less than 30%, preferably less than 22%, for a temperature range of from 30 to 50° C., relative to the initial viscosity of the aqueous composition.

Also according to the invention, the method of heat stabilisation of the viscosity of an aqueous composition comprises the addition of at least one heat-stabilising agent (P) to the aqueous composition for which the decrease in viscosity measured for a shear gradient ranging from 0.1 to 100 s⁻¹ is less than 30%, preferably less than22%, for a temperature range of from 15 to 35° C., relative to the initial viscosity of the aqueous composition.

Also according to the invention, the method of heat stabilisation of the viscosity of an aqueous composition comprises the addition of at least one heat-stabilising agent (P) to the aqueous composition for which the decrease in viscosity measured for a shear gradient ranging from 0.1 to 100 s⁻¹ is less than 20%, preferably less than 12%, for a temperature range of from 5 to 15° C., relative to the initial viscosity of the aqueous composition.

Also preferably, the method of heat stabilisation of the viscosity of an aqueous composition comprises the addition of at least one heat-stabilising agent (P) to the aqueous composition for which the decrease in viscosity measured for a shear gradient ranging from 1 to 100 s⁻¹ is less than 50%, preferably less than 42%, for a temperature range of from 5 to 50° C., relative to the initial viscosity of the aqueous composition.

Also according to the invention, the method of heat stabilisation of the viscosity of an aqueous composition comprises the addition of at least one heat-stabilising agent (P) to the aqueous composition for which the decrease in viscosity measured for a shear gradient ranging from 1 to 100 s⁻¹ is less than 30%, preferably less than 22%, for a temperature range of from 30 to 50° C., relative to the initial viscosity of the aqueous composition.

Also according to the invention, the method of heat stabilisation of the viscosity of an aqueous composition comprises the addition of at least one heat-stabilising agent (P) in the aqueous composition for which the decrease in viscosity measured for a shear gradient ranging from 1 to 100 s⁻¹ is less than 30%, preferably less than 22%, for a temperature range of from 15 to 35° C., relative to the initial viscosity of the aqueous composition.

Also according to the invention, the method of heat stabilisation of the viscosity of an aqueous composition comprises the addition of at least one heat-stabilising agent (P) to the aqueous composition for which the decrease in viscosity measured for a shear gradient ranging from 1 to 100 s⁻¹ is less than 20%, preferably less than 12%, for a temperature range of from 5 to 15° C., relative to the initial viscosity of the aqueous composition.

Also preferably, the of heat stabilisation of the viscosity of an aqueous composition comprises the addition of at least one heat-stabilising agent (P) to the aqueous composition for which the decrease in viscosity measured for a shear gradient ranging from 0.1 to 1 s⁻¹ is less than 50%, preferably less than 38%, for a temperature range of from 5 to 50° C., relative to the initial viscosity of the aqueous composition.

Also according to the invention, the method of heat stabilisation of the viscosity of an aqueous composition comprises the addition of at least one heat-stabilising agent (P) to the aqueous composition for which the decrease in viscosity measured for a shear gradient ranging from 0.1 to 1 s⁻¹ is less than 30%, preferably less than 22%, for a temperature range of from 30 to 50° C., relative to the initial viscosity of the aqueous composition.

Also according to the invention, the method of heat stabilisation of the viscosity of an aqueous composition comprises the addition of at least one heat-stabilising agent (P) in the aqueous composition for which the decrease in viscosity measured for a shear gradient ranging from 0.1 to 1 s⁻¹ is less than 30%, preferably less than 22%, for a temperature range of from 15 to 35° C., relative to the initial viscosity of the aqueous composition.

Also according to the invention, the method of heat stabilisation of the viscosity of an aqueous composition comprises the addition of at least one heat-stabilising agent (P) in the aqueous composition for which the decrease in viscosity measured for a shear gradient ranging from 0.1 to 1 s⁻¹ is less than 20%, preferably less than 12%, for a temperature range of from 5 to 15° C., relative to the initial viscosity of the aqueous composition.

Preferably for the heat stabilisation method according to the invention, from 0.05 to 5% by weight, preferably from 0.1 to 2% by weight, of agent (P) is added to the aqueous composition, relative to the total weight of the composition.

The invention also provides a method for improving the resistance to temperature changes of an aqueous composition comprising the addition of at least one heat-stabilising agent (P) defined according to the invention to the aqueous composition. Particularly advantageously, the method for improving the resistance to temperature changes according to the invention makes it possible to limit or avoid the reduction of the viscosity of the aqueous composition, preferably when there are temperature changes during preparation or during transport or during storage or during the application or use of the aqueous composition according to the invention.

Preferably according to the invention, the method for improving the resistance to temperature changes of an aqueous composition is used at a temperature ranging from 5 to 50° C. or ranging from 30 to 50° C. or ranging from 15 to 35° C. or else ranging from 5 to 15° C.

Preferably for the method for improving the resistance to temperature changes according to the invention, from 0.05 to 5% by weight, preferably from 0.1 to 2% by weight, of agent (P) is added to the aqueous composition, relative to the total weight of the composition. The aqueous composition according to the invention can be used in several technical fields. Preferably, the aqueous composition according to the invention is used in the field of materials in particular in the form of a hydraulic binder composition or an adhesive composition, in the field of detergents in particular in the form of a detergent composition, in the field of cosmetics in particular in the form of a cosmetic composition, in the printing field in particular in the form of an ink composition, in the field of papermaking in particular in the form of an aqueous paper coating composition, in the field of coatings—for example in the fields of varnishes or paints—in particular in the form of a coating composition, in particular a varnish composition or a paint composition or a decorative paint composition or an industrial paint composition.

The invention therefore provides a formulation F comprising at least one aqueous composition according to the invention combined with at least one functional substance that is useful in the field in which the formulation is used.

Preferably, the formulation according to the invention is a coating composition, in particular a varnish composition or a paint composition. The formulation according to the invention therefore combines at least one aqueous composition according to the invention and at least one substance chosen among an organic or inorganic pigment, organic particles, organo-metallic particles, inorganic particles, for example calcium carbonate, talc, kaolin, mica, silicates, silica, metal oxides, in particular titanium dioxide, iron oxides. The formulation according to the invention can also comprise at least one agent chosen among a particle-spacer agent, a dispersing agent, a stabilising steric agent, an electrostatic stabilizer, an opacifying agent, a solvent, a coalescent agent, an anti-foaming agent, a preservative agent, a biocide, a spreading agent, a thickening agent, a film-forming copolymer and mixtures thereof.

Moreover, the formulation according to the invention can be a concentrated aqueous pigment pulp comprising at least one aqueous composition according to the invention and at least one coloured organic or inorganic pigment.

The following examples illustrate the various aspects of the invention.

### EXAMPLES

### Example 1

### Preparation of a Compound (P1) According to the Invention and of a Comparative Compound (CP1)

In a 3 L glass reactor (container 1) equipped with a mechanical stirring, vacuum pump, and nitrogen inlet and heated by means of a double jacket in which oil circulates, 890 g of bi-permuted water is introduced and heated to 75° C. in an inert atmosphere. 10.5 g of sodium dodecyl sulphate powder is then added and the medium is stirred until completely dissolved. In a 1,000 mL glass beaker (container 2) equipped with magnetic stirring, the following are successively added: 338 g of bi-permuted water, 3.4 g of sodium dodecyl sulphate powder which is stirred until completely dissolved, 317 g of ethyl acrylate, 186.2 g of methacrylic acid and 19.5 g of ethoxylated dotriacontane alcohol methacrylate (monoalcohol comprising a branched C₃₂-alkyl group) with 25 ethylene oxide equivalents (compound (a3) of formula (I) wherein R¹ represents a methacrylate group, m represents 25, EO represents an ethylene-oxy group, R² represents a branched C₃₂-alkyl group). This mixture is stirred for 15 minutes to ensure good homogenisation. Then, 1.83 g of ammonium persulphate and 0.183 g of sodium metabisulphite are quickly added to container 1. Then, the contents of container 2 are injected into container 1 with a peristaltic pump over 120 minutes. After 2 hours of reaction, the temperature is increased to 80° C. for 30 minutes. The appropriate amount of water is then added to bring the solids content to 30% by mass. An aqueous emulsion of the heat-stabilising agent (P1) according to the invention is obtained.

Similarly, a comparative compound (CP1) is prepared. In a 3 L glass reactor (container 1) equipped with a mechanical stirring, vacuum pump, and nitrogen inlet and heated by means of a double jacket in which oil circulates, 920 g of bi-permuted water is introduced and heated to 75° C. in an inert atmosphere. 12.9 g of sodium dodecyl sulphate powder is then added and the medium is stirred until completely dissolved.

In a 1,000 mL glass beaker (container 2) equipped with magnetic stirring, the following are successively added: 321 g of bi-permuted water, 4.5 g of sodium dodecyl sulphate which is stirred until completely dissolved, 311.5 g of ethyl acrylate, 180 g of methacrylic acid and 27.2 g of ethoxylated behenyl alcohol methacrylate with 25 equivalents of ethylene oxide. This mixture is stirred for 15 minutes to ensure proper homogenisation. Then, 1.8 g of ammonium persulphate and 0.18 g of sodium metabisulphite are quickly added to container 1. Then, the contents of container 2 are injected into container 1 with a peristaltic pump over 120 minutes. After 2 hours of reaction, the temperature is increased to 80° C. for 30 minutes. An aqueous emulsion of a comparative compound (CP1) is obtained.

### Example 2

### Preparation and Evaluation of Aqueous Formulations Comprising a Heat-Stabilising Agent (P1) According to the Invention or a Comparative Compound (CP1)

6.7 g of aqueous emulsion of heat-stabilising agent (P1) in example 1 is weighed in a 500 mL glass beaker. 393.3 g of bi-permuted water is then added in order to obtain 400 g of aqueous solution of heat-stabilising agent (P1). This solution is placed under vigorous mechanical stirring. Then, its pH is brought to 8+/−1 by adding an aqueous sodium hydroxide solution at 50% by mass. Stirring is continued for 2 minutes, then the gel is left to rest for 24 hours.

Similarly, a comparative formulation CF1 comprising a comparative compound (CP1) is prepared instead of the agent (P1).

8 g of aqueous emulsion of comparative compound (CP1) in example 1 is weighed in a 500 mL glass beaker. 392 g of bi-permuted water are then added in order to obtain 400 g of aqueous solution of compound (CP1). This solution is placed under vigorous mechanical stirring. Then, its pH is brought to 8+/−1 by adding an aqueous sodium hydroxide solution at 50% by mass. Stirring is continued for 2 minutes, then the gel is left to rest for 24 hours. The amount of water in the formulation CF1 can be adjusted so that this formulation has a starting viscosity comparable to that of the formulation F1.

The thickening efficacy of the formulations is assessed after 24 hours by measuring flow curves for various shear gradients (Thermo Scientific Mars III rheometer using a cone-planar geometry of 60 mm in diameter with a 1° angle) and at different temperatures.

The heat stability of the formulation is then assessed by calculating the change in viscosity depending on the temperature change for the various shear gradients applied. The change in viscosity is calculated in a standardized manner relative to the viscosity measured at 4.9° C. For each viscosity value measured, the ratio R (viscosity measured at a certain temperature/viscosity measured at 4.9° C.) corresponding to the residual viscosity of each formulation assessed, is calculated.

The results of the viscosity values and R ratios for the formulation F1 comprising the agent (P1) according to the invention are shown in Table 1.

| Formulation F1 comprising the agent (P1) | | | |
|---|---|---|---|
| Viscosity (mPa · s) | | | |
| Temperature | per shear gradient (s⁻¹) | | |
| (° C.) | 0.1 | 1 | 100 |
| 4.9 | 189.80 | 23.52 | 0.46 |
| 10.0 | 184.50 | 21.98 | 0.43 |
| 14.9 | 180.30 | 20.80 | 0.41 |
| 20.0 | 168.70 | 19.48 | 0.38 |
| 24.9 | 159.80 | 18.84 | 0.36 |
| 29.9 | 152.00 | 18.26 | 0.34 |
| 35.0 | 138.20 | 17.44 | 0.32 |
| 39.9 | 131.20 | 16.91 | 0.30 |
| 45.1 | 122.50 | 16.07 | 0.28 |
| 50.0 | 118.30 | 15.34 | 0.27 |

R

| Temperature | per shear gradient (s⁻¹) | | |
|---|---|---|---|
| (° C.) | 0.1 | 1 | 100 |
| 4.9 | 1.00 | 1.00 | 1.00 |
| 10.0 | 0.97 | 0.93 | 0.93 |
| 14.9 | 0.95 | 0.88 | 0.88 |
| 20.0 | 0.89 | 0.83 | 0.82 |
| 24.9 | 0.84 | 0.80 | 0.78 |
| 29.9 | 0.80 | 0.78 | 0.75 |
| 35.0 | 0.73 | 0.74 | 0.70 |
| 39.9 | 0.69 | 0.72 | 0.66 |
| 45.1 | 0.65 | 0.68 | 0.61 |
| 50.0 | 0.62 | 0.65 | 0.58 |

The results of the viscosity values and R ratios for the comparative formulation CF1 comprising the comparative polymer (CP1) are shown in Table 2.

| Formulation CF1 comprising the agent (CPI) | | | |
|---|---|---|---|
| Viscosity (mPa · s) | | | |
| Temperature | per shear gradient (s⁻¹) | | |
| (° C.) | 0.1 | 1 | 100 |
| 4.9 | 20.30 | 15.20 | 16.20 |
| 10.0 | 18.27 | 14.04 | 14.39 |
| 14.9 | 16.74 | 13.02 | 13.31 |
| 20.0 | 12.82 | 10.80 | 11.06 |
| 24.9 | 9.91 | 9.08 | 9.25 |
| 29.9 | 7.20 | 7.25 | 7.35 |
| 35.0 | 4.05 | 4.59 | 4.63 |
| 39.9 | 2.61 | 3.08 | 3.10 |
| 45.1 | 1.29 | 1.48 | 1.47 |
| 50.0 | 0.79 | 0.86 | 0.85 |

R

| Temperature | per shear gradient (s⁻¹) | | |
|---|---|---|---|
| (° C.) | 0.1 | 1 | 100 |
| 4.9 | 1.00 | 1.00 | 1.00 |
| 10.0 | 0.90 | 0.92 | 0.89 |
| 14.9 | 0.82 | 0.86 | 0.82 |
| 20.0 | 0.63 | 0.71 | 0.68 |
| 24.9 | 0.49 | 0.60 | 0.57 |
| 29.9 | 0.35 | 0.48 | 0.45 |
| 35.0 | 0.20 | 0.30 | 0.29 |
| 39.9 | 0.13 | 0.20 | 0.19 |
| 45.1 | 0.06 | 0.10 | 0.09 |
| 50.0 | 0.04 | 0.06 | 0.05 |

For different shear gradients, the change in viscosity of the formulations comprising an agent (P1) according to the invention or a comparative polymer (CP1) is compared for various temperature ranges by calculating the viscosity loss. The viscosity loss results are shown in Table 3.

| | Temperature | Viscosity loss (%) per | | |
|---|---|---|---|---|
| | range | shear gradient (s⁻¹) | | |
| Formulation | (° C.) | 0.1 | 1 | 100 |
| with (P1) | 5->15 | 5 | 12 | 12 |
| | 15->35 | 23 | 16 | 21 |
| | 30->50 | 22 | 16 | 22 |
| | 5->50 | 38 | 35 | 45 |
| with (CP1) | | 0.1 | 1 | 100 |
| | 5->15 | 18 | 14 | 18 |
| | 15->35 | 76 | 65 | 65 |
| | 30->50 | 89 | 22 | 88 |
| | 5->50 | 96 | 94 | 95 |

For many temperature ranges, it is possible to observe that the heat-stabilising agents according to the invention make it possible to limit the viscosity loss much more significantly than the comparative polymer. This viscosity stabilisation is possible for shear gradients corresponding to many conditions of use or application of aqueous compositions.

1. A method for preparing an aqueous composition that is heat-resistant to temperature variations, the method comprising:
adding at least one heat-stabilizing agent (P) comprising, in polymerized form:
(a1) an anionic monomer comprising a polymerizable olefinic unsaturation and a carboxylic acid group, optionally in salt form;
(a2) a C1-C7 ester of acrylic acid, methacrylic acid, maleic acid, and/or itaconic acid;
(a3) an associative monomer of formula (I):
R¹-(EO)ₘ-(PO)ₙ-R² (I),
wherein:
m and n are independently 0 or an integer or decimal less than 150, m or n being different from 0,
EO is independently a CH₂CH₂O group,
PO is independently a combination of (i) CH₂CH₂O and (ii) CH(CH₃)CH₂O and/or CH₂CH(CH₃)O,
R¹ is independently a group comprising a polymerizable olefinic unsaturation, and
R² is independently a straight C₂₈-C₄₀-alkyl group or a C₂₈-C₄₀-alkyl group.

2. The method of claim 1 wherein the aqueous composition is a hydraulic binder composition, an adhesive composition, a detergent composition, a cosmetic composition, an ink composition, an aqueous paper coating composition, or a coating composition.

3. The method of claim 1, wherein:
the monomer (a1) is acrylic acid, methacrylic acid, an acrylic acid salt, a methacrylic acid salt, or a combination thereof, or
the monomer (a2) is a C₁-C₆ ester, or
the monomer (a3) is a compound of formula (I) wherein:
m and n are independently 0 or an integer or decimal less than 150,
EO is independently a CH₂CH₂O group,
PO is independently a combination of (i) CH₂CH₂O and (ii) CH(CH₃)CH₂O and/or CH₂CH(CH₃)O,
R¹ is independently an acrylate group or a methacrylate group, and
R² is independently a straight C₃₂-C₄₀-alkyl group, a branched C₃₂-C₄₀-alkyl group, a straight C₃₀-C₃₆-alkyl group, or a branched C₃₀-C₃₆-alkyl group.

4. The method of claim 1, wherein a polymerization reaction for the heat-stabilizing agent (P) uses, relative to total monomer weight:
the monomer (a1) in a range of from 20 to 55 wt. %,
the monomer (a2) in a range of from 20 to 79.5 wt. %, and
the monomer (a3) in a range of from 0.5 to 25 wt. %.

5. The method of claim 1, wherein the heat-stabilizing agent (P) is prepared polymerizing:
(a4) 2 acrylamido-2-methylpropane sulphonic acid, ethoxymethacrylate sulphonic acid, sodium methallyl sulphonate, styrene sulphonate, hydroxyethyl acrylate phosphate, hydroxypropyl acrylate phosphate, hydroxyethylhexyl acrylate phosphate, hydroxyethyl methacrylate phosphate, hydroxypropyl methacrylate phosphate, hydroxyethylhexyl methacrylate phosphate, or a combination thereof, optionally in salt form,
(a5) hydroxyethyl acrylate, hydroxypropyl acrylate, hydroxyethylhexyl acrylate, hydroxyethyl methacrylate, hydroxypropyl methacrylate, hydroxyethylhexyl methacrylate, or a combination thereof,
(a6) at least one cross-linking monomer or at least one monomer comprising at least two olefinic unsaturations,
(a7) at least one chain transfer agent.

6. The method of claim 1 wherein the heat-stabilizing
agent (P)
is at least partially neutralized, or
is partially coacervated.

7. The method of claim 1, wherein the aqueous composition comprises from 0.05 to 5 wt. % of the heat-stabilizing agent (P), relative to total aqueous composition weight.

8. The method of claim 1, wherein the aqueous composition has a viscosity:
measured for a shear gradient in a range of from 0.1 to 1,000 s⁻¹ and for a temperature change in a range of from 5 to 50° C., in a range of from 50 to 98%, of the initial viscosity value of the aqueous composition, or
measured for a shear gradient in a range of from 0.1 to 100 s⁻¹ and for a temperature change in a range of from 5 to 50° C., in a range of from 50 to 98%, of the initial viscosity value of the aqueous composition or
measured for a shear gradient in a range of from 1 to 100 s⁻¹ and for a temperature change in a range of from 5 to 50° C., in a range of from 50 to 98%, of the initial viscosity value of the aqueous composition or
measured for a shear gradient in a range of from 0.1 to 1 s⁻¹ and for a temperature change in a range of from 5 to 50° C., in a range of from 55 to 98%, of the initial viscosity value of the aqueous composition.

9. A method of heat stabilizing viscosity of an aqueous composition, the method comprising:
adding at least one of the heat-stabilizing agent (P) of claim 1 to the aqueous composition,
wherein a decrease in viscosity measured for a shear gradient in a range of from 0.1 to 1,000 s⁻¹ is less than 45%, for a temperature range in a range of from 5 to 50° C., relative to an initial viscosity of the aqueous composition, or
wherein a decrease in viscosity measured for a shear gradient in a range of from 0.1 to 100 s⁻¹ is less than 50%, for a temperature range in a range of from 5 to 50° C., relative to the initial viscosity of the aqueous composition, or
wherein the decrease in viscosity measured for a shear gradient in a range of from 1 to 100 s⁻¹ is less than 50%, for a temperature range in a range of from 5 to 50° C., relative to the initial viscosity of the aqueous composition, or
wherein a decrease in viscosity measured for a shear gradient in a range of from 0.1 to 1 s⁻¹ is less than 50%, for a temperature range in a range of from 5 to 50° C., relative to the initial viscosity of the aqueous composition.

10. The method of claim 9, wherein the heat-stabilizing agent (P) is added in a range of from 0.05 to 5 wt. % to the aqueous composition, relative to total aqueous composition weight.

11. A method for improving resistance to temperature changes of an aqueous composition, the method comprising:
adding at least one of the heat-stabilizing agent (P) of claim 1 to the aqueous composition.

12. The method of claim 1, wherein the aqueous composition is a varnish composition.

13. The method of claim 1 wherein the aqueous composition is a paint composition.

14. The method of claim 1, wherein the monomer (a1) is acrylic acid, methacrylic acid, an acrylic acid salt, and/or a methacrylic acid salt.

15. The method of claim 1, wherein the monomer (a2) is methyl acrylate, ethyl acrylate, propyl acrylate, butyl acrylate, ethyl hexyl acrylate, methyl methacrylate, ethyl methacrylate, propyl methacrylate, butyl methacrylate, ethyl hexyl methacrylate, or a combination thereof.

16. The method of claim 1, wherein the monomer (a2) is ethyl acrylate, butyl acrylate, methyl methacrylate, or a combination thereof.

17. The method of claim 3, wherein, in the monomer (a3), R² is independently a straight C₃₂-C₃₆-alkyl group or a branched C₃₂-C₃₆-alkyl group; more preferentially a branched C₃₂-alkyl group.

18. The method of claim 1, wherein a polymerization reaction for the heat-stabilizing agent (P) uses, relative to total monomer weight, the monomer (a1) in a range of from 25 to 45 wt. %,
the monomer (a2) in a range of from 35 to 74 wt. %, and
the monomer (a3) in a range of from 1 to 20 wt. %.
